(19) United States
(12) Patent Application Publication
(10) Pub. No.: US 2009/0135479 A1
(43) Pub. Date: May 28, 2009

(54) Universal Mount for Night Vision Goggles

(76) Inventors: Ronald R. Soto, Laguna Hills, CA (US); Jonathon R. Prendergast, Newport Beach, CA (US)

Correspondence Address: CHRISTIE, PARKER & HALE, LLP, PO BOX 7068, PASADENA, CA, 91109-7068, US

(21) Appl. No.: 12/263,446

(22) Filed: Oct. 31, 2008

Related U.S. Application Data
(60) Provisional application No. 61/001,662, filed on Nov. 2, 2007.

(51) Int. Cl. G02B 23/16

(52) U.S. Cl. 359/409

(57) ABSTRACT

A mount for night vision goggles including a bracket configured to attach the mount to headgear and a chassis base extending from the bracket. A first socket assembly is attached to the chassis base, the first socket assembly adapted to receive a first type of night vision goggle attachment. A second socket assembly configured to mate with a second type of night vision goggle attachment is provided, the second socket assembly attachable to the first socket assembly to substantially prevent relative movement between the first socket assembly and the second socket assembly.

### CROSS-REFERENCE TO RELATED APPLICATION

This application claims priority to and the benefit of U.S. Provisional Application No. 60/001,662, filed in the United States Patent and Trademark Office on Nov. 2, 2007, the entire content of which is incorporated herein by reference.

### FIELD OF THE INVENTION

This invention relates generally to mounting assemblies for night vision devices.

### BACKGROUND OF THE INVENTION

Night vision devices are commonly used by military personnel for conducting operations in low light or night conditions. The night vision devices used by the military typically include image intensifier tubes and associated optics that convert infrared and near infrared light into viewable images. A common night vision device currently being used in the U.S. Army is the PVS7 night vision device, manufactured by ITT Corporation in Roanoke, Va.

Assemblies for mounting night vision devices to a helmet are well known in the art. These mounting assemblies allow a user's hands to remain free while the user views a scene through the night vision device. Various assemblies for attaching night vision goggles to a night vision goggle helmet mount exist, including a goggle horn assembly, a dovetail assembly, and a tip-in interface assembly. Additional assemblies might be developed in the future. Since it is often not feasible or convenient for soldiers to carry multiple helmet mount assemblies with them to allow attachment of night vision goggles with the appropriate attachment assembly, there is a need for a single helmet mount that allows various attachment assemblies to be attached thereto.

It is known to provide an adapter for a helmet mount that is adapted to receive a first type of attachment assembly, such as a goggle horn assembly, and that includes a second type of attachment assembly, such as a dovetail assembly, that mates with a dovetail receiving area on the helmet mount. However, such an adapter requires attachments between components that allow undesirable relative movement between the components and may compromise a user's ability to focus or maintain viewing clarity. Additionally, the movement between the components accelerates wear and decreases longevity of the product while creating a rattle or other noise between components generated upon movement, that may alert an enemy to a soldier's location. As such, there is a desire for a single helmet mount that allows various attachment assemblies to be attached thereto, but may include only a single attachment for the night vision goggles and the helmet mount to form a rigidly mounted mechanical device.

### SUMMARY OF THE INVENTION

Embodiments of the present invention are directed to a helmet mount providing a rigid structure adapted to receive at least two different types of night vision goggle mounts such that a single helmet mount may be used with different night vision goggle mounts while minimizing relative movement between the helmet mount and the night vision goggles and noise created by the helmet mount, and maximizing longevity of the helmet mount.

A mount for night vision goggles including a bracket configured to attach the mount to headgear and a chassis base extending from the bracket. A first socket assembly is attached to the chassis base, the first socket assembly adapted to receive a first type of night vision goggle attachment. A second socket assembly configured to mate with a second type of night vision goggle attachment is provided, the second socket assembly attachable to the first socket assembly to substantially prevent relative movement between the first socket assembly and the second socket assembly.

In one embodiment, the first socket assembly is stacked onto the second socket assembly, and the socket assemblies may be attached by a single fastener or by a plurality of fasteners. The first socket assembly and the second socket assembly may each have at least one bore for receiving a fastener to attach the first socket assembly to the second socket assembly.

The second socket assembly may include an alignment protrusion extending from a top surface, wherein the first socket assembly has an alignment cavity adapted to receive the alignment protrusion. In one embodiment, a fastener is insertable into the alignment cavity and the alignment protrusion to attach the first socket assembly to the second socket assembly. The alignment protrusion may be a non-radially symmetrical shape, such as a trapezoid.

The chassis base may include a pair of rails and the first socket assembly may include a pair of through holes for mounting the first socket assembly on the pair of rails. Further, the first and second socket assemblies may be, for example, a dovetail assembly, a goggle horn assembly, and/or a tip-in assembly. If the first socket assembly is a tip-in assembly, the second socket assembly may include a tip-in hot shoe attached to a top surface, the tip-in hot shoe adapted to attach the second socket assembly to the first socket assembly. The second socket assembly may include an alignment protrusion attached to the top surface, the alignment protrusion adapted to be inserted into an alignment cavity of the tip-in hot shoe.

In one embodiment, the helmet mount may include an automatic shutdown assembly device, for example, magnet module, attached to at least one of the first socket assembly and the second socket assembly.

In another embodiment a mount for night vision goggles includes a bracket configured to attach the mount to headgear and a chassis base extending from the bracket and including a pair of rails. A universal attachment member defining a first surface comprising a pair of through holes is slidably attachable to the pair of rails and defining a second surface opposite the first surface having one of protrusions or recesses for receiving a night vision goggle socket assembly. A night vision goggle socket assembly is also provided defining a first surface including the other of protrusions or recesses configured to mate with the protrusions or recesses on the second su ace of the universal attachment member.

### BRIEF DESCRIPTION OF THE DRAWINGS

FIG. 1 is a perspective view of a helmet mount including an exemplary universal mount assembly of the present invention connected thereto.

FIGS. 2-4 are a perspective front view, a perspective rear view, and a partially exploded perspective view of the exemplary universal mount of FIG. 1.

FIG. 5 is a bottom view of an exemplary dovetail socket assembly of the present invention.

FIG. 6 is a perspective view of an exemplary goggle horn socket assembly of the present invention.

FIGS. 7A, 7B and 8 are a perspective front view, a perspective rear view and a partially exploded perspective view of another exemplary universal mount of the present invention.

FIGS. 9-11 are a perspective front view, a perspective rear view, and a partially exploded perspective view of yet another exemplary universal mount of the present invention.

FIGS. 12-14 are a perspective rear view, a perspective front view, and a partially exploded perspective view of still another exemplary universal mount of the present invention.

FIGS. 15-17 are a perspective rear view, a perspective front view, and a partially exploded perspective view of yet another exemplary universal mount of the present invention.

FIGS. 18-20 are a perspective front view, a perspective rear view, and a partially exploded perspective view of still another exemplary universal mount of the present invention.

FIGS. 21-23 are a perspective rear view, a perspective front view, and a partially exploded perspective view of yet another exemplary universal mount of the present invention.

FIG. 24 is schematic perspective view of a dovetail socket assembly having another exemplary attachment surface of the present invention.

FIG. 25 is a schematic bottom view of an exemplary attachment member of the present invention.

FIG. 26 is a schematic side view of an exemplary attachment member of the present invention.

### DETAILED DESCRIPTION OF THE INVENTION

In general, a universal mount for night vision goggles is provided to allow various mount configurations to be stacked together to form a rigid device. More specifically, the universal mount allows night vision goggles attached to one of various types of goggle mount to be mated with a corresponding assembly attached to headgear to allow the night vision goggles to be attached to the headgear and operated hands-free. Accordingly, the universal mount can be used with a variety of mounts attached to night vision goggle assemblies while minimizing relative movement of the goggles with respect to the mount and noise created by the mount and maximizing the longevity of the universal mount. Any first mount configuration may be attached to the helmet mount, and any second mount configuration may be attached to the first mount configuration. As will be understood, additional mount configurations may be added to the first two mount configurations as necessary or desired.

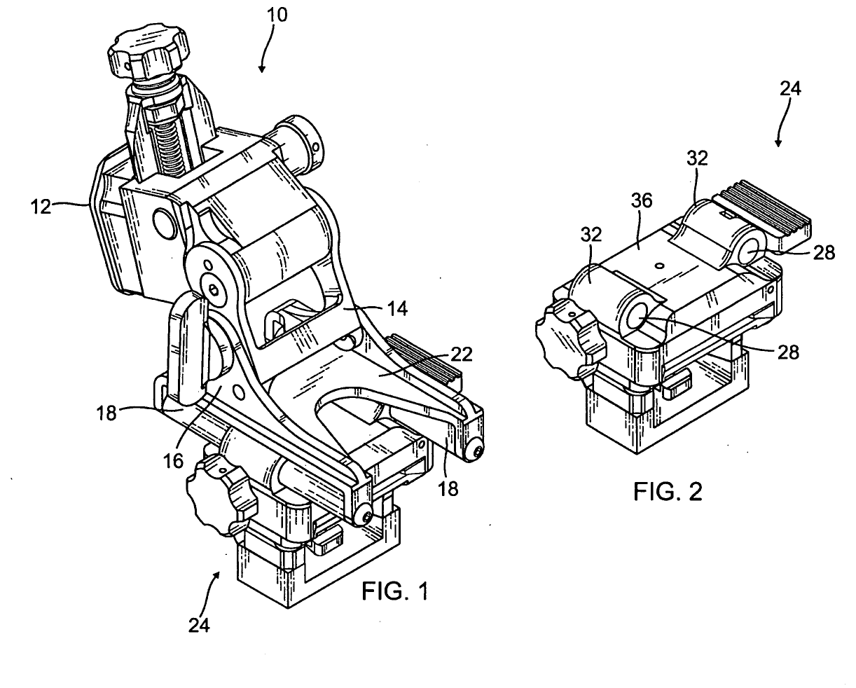

It will be appreciated that numerous helmet mounts may be used in connection with the present invention, such as those described in U.S. Pat. Nos. 7,418,738, filed on Feb. 4, 2005 (Prendergast), and 6,472,776, filed Mar. 3, 2000 (Soto et al.), and in U.S. patent application Ser. No. 11/473,495, filed Jun. 23, 2006 (Prendergast), the entire contents of which are incorporated herein by reference. Referring now to FIG. 1, a helmet mount 10 for night vision goggles is provided, the helmet mount being attachable to a helmet or other headgear by an attachment plate 12. In one exemplary embodiment, the helmet mount 10 includes a bracket member 14 to which the attachment plate 12 is connected. A chassis 16 is attached to the bracket member 14, the chassis including a pair of rails 18 separated by a reinforcing plate 22. As described in more detail below, a dual universal mount assembly 24 adapted to receive night vision goggles may be slidably attached to the rails 18.

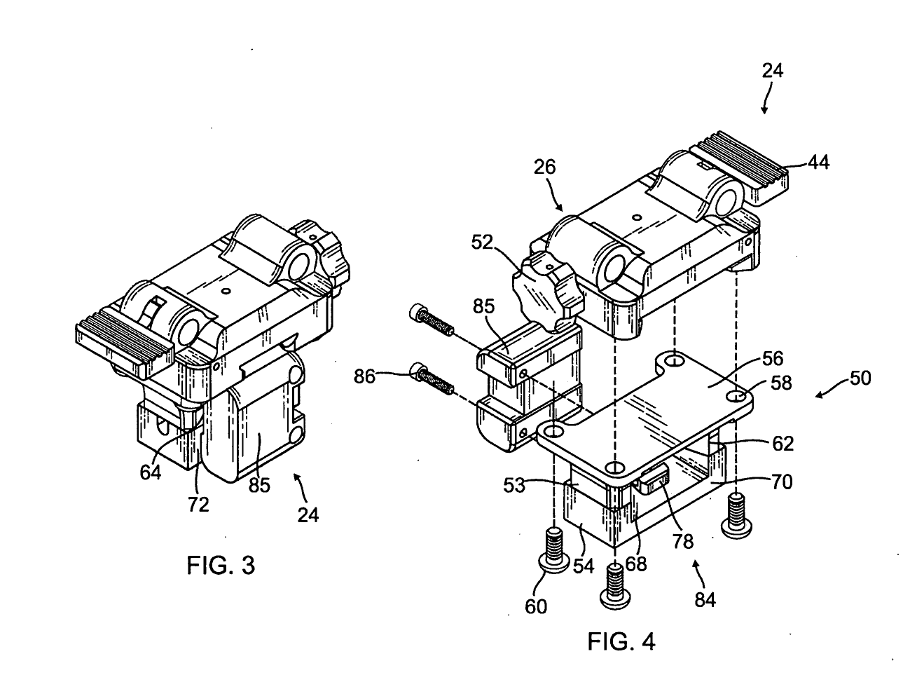

With reference now also to FIGS. 2-4, in one exemplary embodiment, the dual mount assembly 24 includes a dovetail socket assembly 26 configured to receive a dovetail goggle mount and a goggle horn socket assembly 50 configured to receive a goggle horn. The dovetail socket assembly 26 includes a pair of bores or channels 28 extending through partially cylindrical protrusions 32, respectively, extending from a top surface 36 of the dovetail socket assembly 24. The bores 28, 30 are sized to be slidably engageable with the rails 18 to attach the universal mount assembly 24 to the chassis 16 and to allow movement of the universal mount assembly toward and away from a user when the helmet mount 10 is attached to a helmet while substantially preventing any relative vertical movement between the bores 28 and the rails 18.

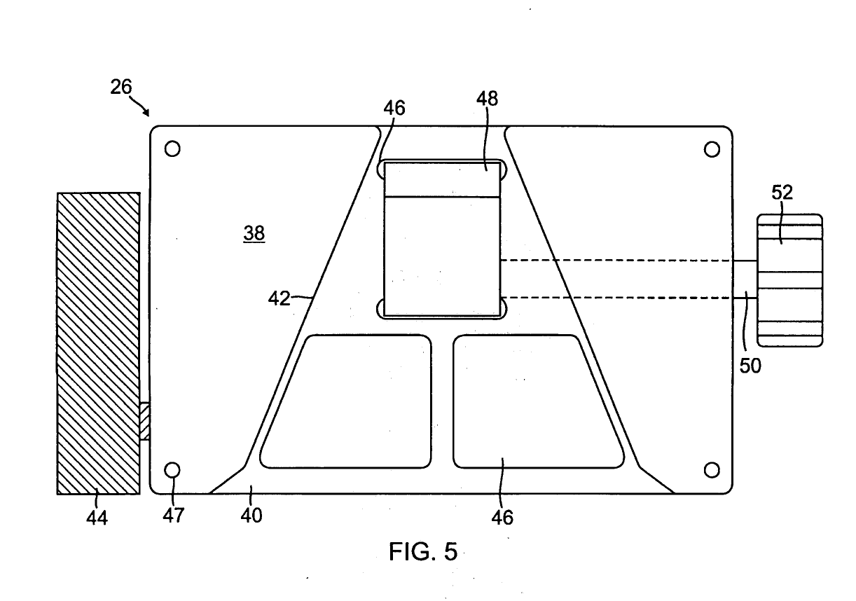

With reference now also to FIG. 5, the dovetail socket assembly 26 further includes a contacting surface 38 and a dovetail receiving area 40. The contacting surface 38 may include bores 47 adapted to receive a fastener for connection of a mount, as described in more detail below. The dovetail receiving area has a pair of rails 42 extending between the contacting surface 38 and the dovetail receiving area 40 that are adapted to slidingly receive an edge of a dovetail mount attached to night vision goggles (not shown) to secure night vision goggles to the helmet mount 10, as is well-known. The dovetail receiving area 40 may also include at least one dugout 46 housing a detent 48. The detent 48 is rotatable between a disengaged position in which the detent is flush with or recessed from the dovetail receiving area to allow insertion of a dovetail mount and an engaged position in which at least a portion of the detent protrudes from the dovetail receiving area to engage and secure a dovetail mount inserted into the dovetail receiving area 40. A rod 50 is connected to the detent 48 and rotatably secures the detent within the dugout 46. A knob 52 may be attached to one end of the rod 50 such that rotation of the knob results in rotation of the detent 48 between the engaged position and the disengaged position. In one exemplary embodiment, a spring (not shown) may bias the detent 48 into the engaged position, thereby allowing the detent to secure the night vision goggles to the dovetail socket assembly 26. The dovetail socket assembly 26 may also include an adjustment lever 44 that allows a user to slide the socket assembly along the rails 18 when the lever is in a disengaged position, and that secures the socket assembly in place when the lever is in an engaged position.

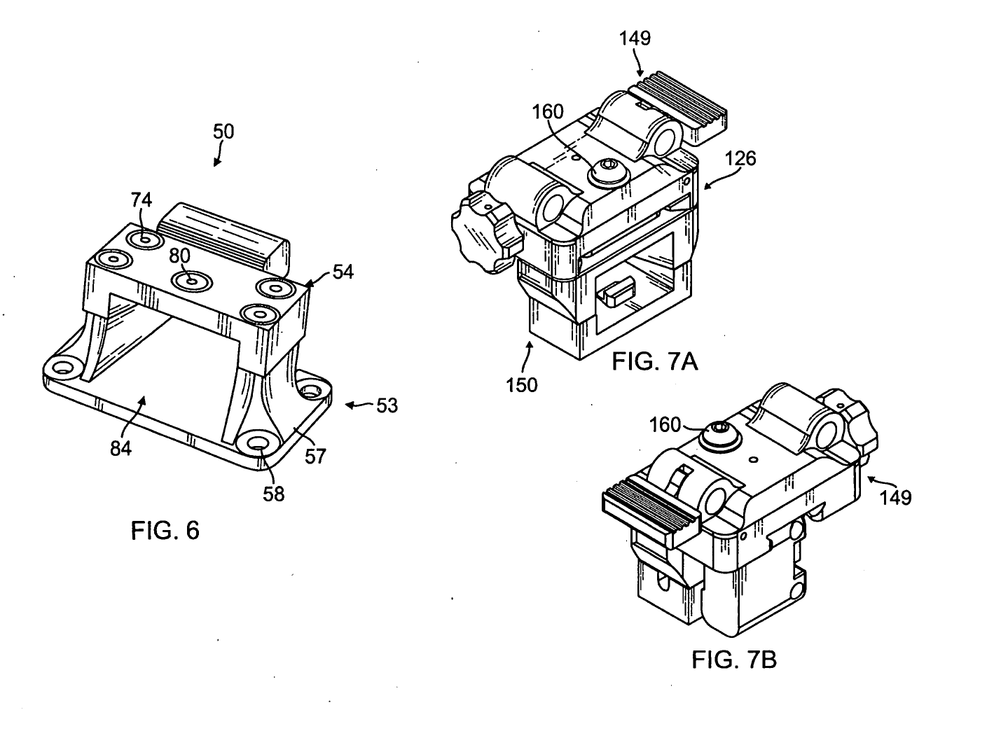

As shown in FIG. 4, in one exemplary embodiment, a goggle horn socket assembly 50 is rigidly attachable to the dovetail socket assembly 26 to form the dual mount assembly 24 and to allow night vision goggles with a second type of mount to be attached to the mount assembly. The goggle horn socket assembly 50 may comprise an upper socket 53 and a lower socket 54. With reference also to FIG. 6, the upper socket 53 comprises an attachment plate 56 including symmetrical lateral flanges 57 having a plurality of through holes 58 through which fasteners 60, such as screws, may be inserted to connect the goggle horn socket assembly 50 to the dovetail socket assembly 26. A substantially U-shaped wall structure including two sidewalls 62 and a rear wall 64 (FIG. 3) forming a portion of a receiving area 84, as described in more detail below, extends from the attachment plate 56. A bottom surface of the sidewalls 62 and the rear wall 64 may include a plurality of threaded bores (not shown) each adapted to receive a fastener 74, such as a screw. The lower socket 54 comprises a base wall 68, sidewalls 70 and a rear wall 72 alignable with and generally corresponding to the sidewalls 62 and rear wall of the upper socket 53. A goggle horn detent 78 engageable with a goggle horn to secure the goggle horn to the goggle horn socket assembly 50 may protrude from the base wall 68. The goggle horn detent 78 may be attached by a fastener 80 inserted into a through hole in the base wall 68. However, the goggle horn detent 78 may also be attached by another other suitable means, such as adhesive or welding. The lower socket 54 may further include a plurality of through holes 58 adapted to receive fasteners 74 to attach the lower socket to the upper socket 53. Because the goggle horn socket assembly 50 is attached to the dovetail socket assembly 26 at multiple attachment points, the two socket assemblies can be rigidly attached. Although particular relatively permanent fasteners have been described herein, one of ordinary skill in the art will also appreciate that other more temporary fasteners, such as a quick release assembly and/or a latch, may be used to securely fasten the dual mount assembly 24. Additionally, such fasteners may be used with other mount assemblies described and contemplated herein.

When the upper socket 53 and the lower socket 54 are attached to form the goggle horn socket assembly 50, a goggle horn receiving area 84 is created within the side walls 62, 70 and rear walls 64, 72. In one exemplary embodiment, the sidewalls 62, 70 and the base wall 68 are angled inwardly into the goggle horn receiving area 84 to substantially match the shape of the goggle horn. Further, the upper socket 53 and the lower socket 54 may be spring loaded to provide limited adjustability between the sockets to allow slight variations in the size of goggle horns inserted into goggle horn socket assembly 50.

A magnet module 85, such as the one described in U.S. Pat. No. 6,862,748, filed on Mar. 17, 2003, the entire content of which is incorporated herein by reference, is attachable to the goggle horn socket assembly 50 by, for example, screws 86 threadable into bores in the rear walls 64, 72.

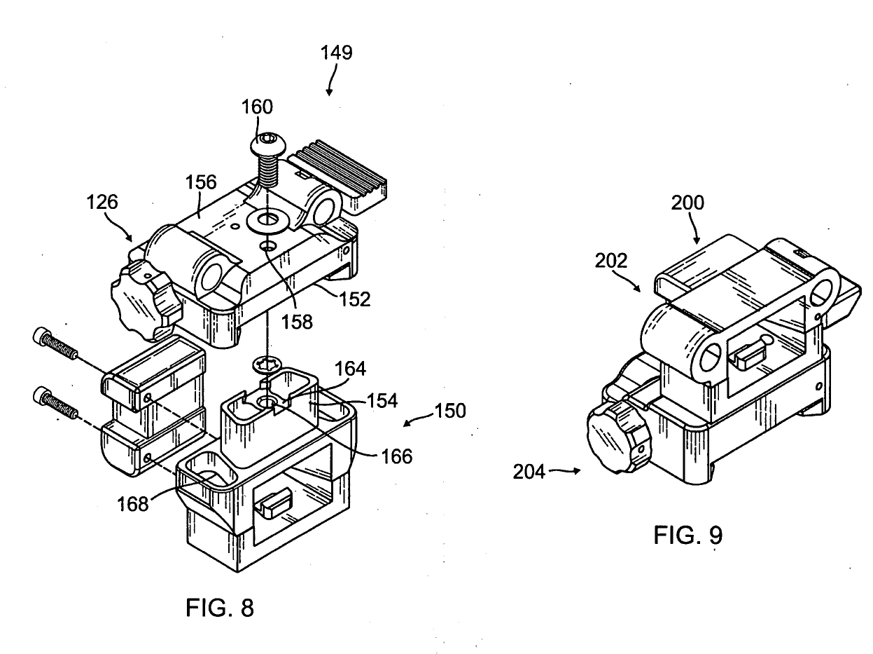

As shown in FIGS. 7A, 7B and 8, another exemplary embodiment of a dual mount assembly 149 is provided and configured such that a single fastener 160 may be used to connect a dovetail socket assembly 126 and a goggle horn socket assembly 150. The dovetail socket assembly 126 includes an alignment cavity 152 adapted to receive an alignment protrusion 154 on the goggle horn socket assembly 150. In one exemplary embodiment, a top wall 156 of the dovetail socket assembly 126 includes a through hole 158 adapted to receive the single fastener 160 to attach the dovetail socket assembly 126 to the goggle horn socket assembly 150. The alignment protrusion 154 extends from a top surface 162 of the goggle horn socket assembly 150, and may comprise a generally hollow trapezoidal cross-section or other non-radially symmetrical cross-section such that the goggle horn socket assembly 150 cannot be installed backwards onto the dovetail socket assembly 126 and also to substantially prevent rotation between the dovetail socket assembly 126 and the goggle horn socket assembly 150. A support column 164 including a threaded bore 166 adapted to receive the fastener 160 extends across a width of the alignment protrusion 154. Further, a pair of dugouts 168 may be located on either side of the protrusion 154 to minimize the weight of the dual mount assembly 149.

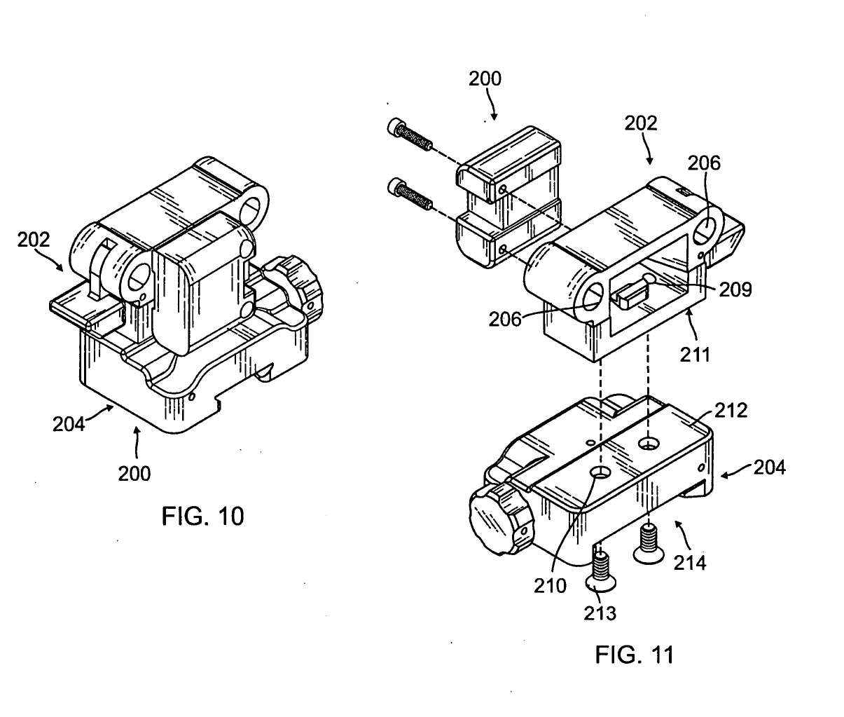

With reference now to FIGS. 9-11, in another exemplary embodiment of a dual mount assembly 200, a goggle horn socket assembly 202 is adapted to be slidably connected to the rails 18 of the chassis base 16, and a dovetail socket assembly 204 is adapted to be attached underneath the goggle horn socket assembly 202. More specifically, the goggle horn socket assembly 202 has a pair of bores or channels 206 for slidably connecting the goggle horn socket assembly to the rails 18 similarly to the exemplary embodiment described above. In one exemplary embodiment, the goggle horn socket assembly 202 has a bottom surface 211 generally corresponding to a top surface 212 of the dovetail socket assembly 204. The goggle horn socket assembly 202 may include threaded bores 209 into which fasteners 213 may be inserted to attach the goggle horn socket assembly to the dovetail socket assembly 204. Similarly, the dovetail socket assembly 204 may include through holes 210 in a top surface 212 alignable with threaded bores 209 and through which the fasteners 213 are insertable. Further, an interior upper surface of the dovetail socket assembly 204 may be recessed such that a head of the fastener 213 may be flush with or recessed from a dovetail receiving area 214 when the socket assemblies 202, 204 are attached so as to not interfere with a dovetail mount inserted into the dovetail receiving area.

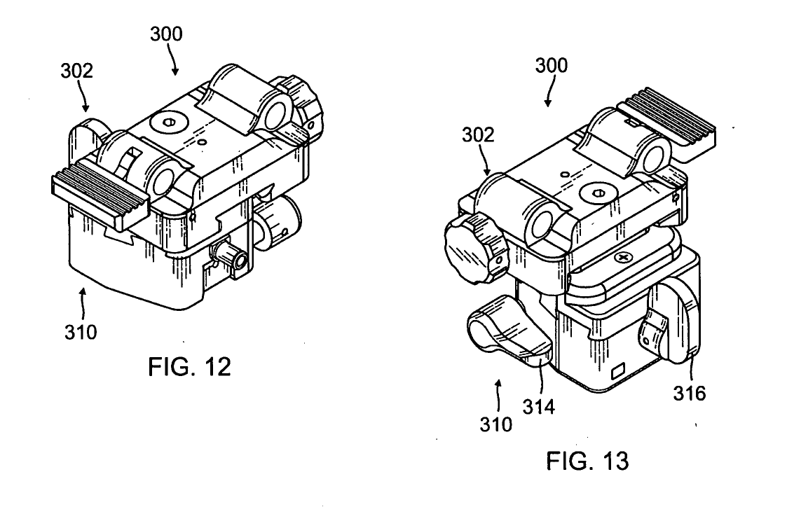

With reference now to FIGS. 12-14, yet another exemplary embodiment of a dual mount assembly 300 is provided. The dual mount assembly 300 includes a dovetail socket assembly 302, similar to the previously described dovetail socket assemblies, having an alignment recess and a through hole 306 adapted to receive a fastener 308. The dual mount assembly 300 further includes a tip-in socket assembly 310 for providing an electrical connection to enhanced night vision goggles (ENVG), such as the ones described in U.S. patent application Ser. No. 11/473,495, and incorporated herein by reference above. The tip-in socket assembly 310 generally includes a housing 312 having a recess 313 adapted to receive an ENVG attachment plate (not shown). The housing 312 may further include a release lever 314 to disengage the ENVG from the tip-in socket assembly 310 and a lateral adjustment lever 316 to allow a user to align an attached ENVG to his eyes. A top surface 318 of the housing 312 may include an alignment protrusion 320 comprising a generally trapezoidal cross-section or other non-symmetrical cross-section such that the tip-in socket assembly 310 cannot be installed backwards onto the dovetail socket assembly 302 and to substantially prevent relative rotation between the dovetail socket assembly and the tip-in socket assembly. A support column 321 including a threaded bore 322 adapted to receive the fastener 308 extends across a width of the alignment protrusion 320. A pair of dugouts 324 may be located on either side of the alignment protrusion 320 to minimize the weight of the dual mount assembly 300.

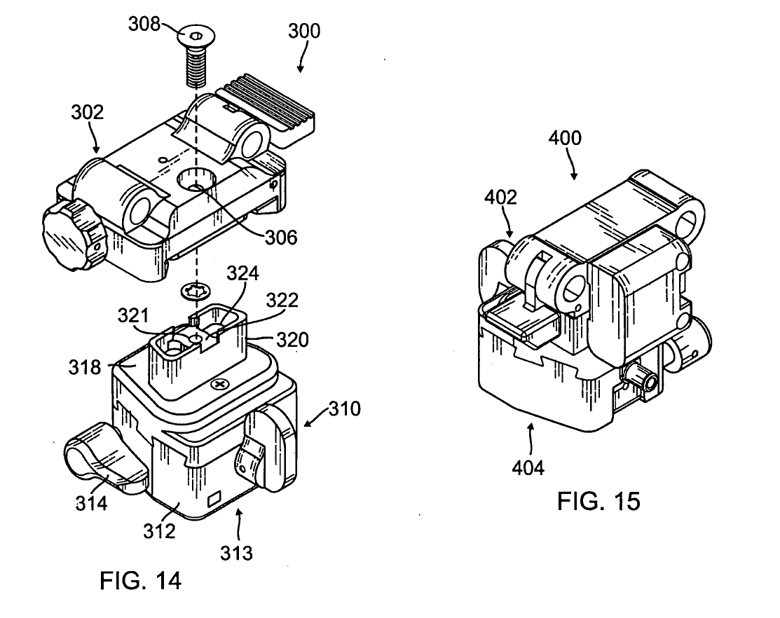

With reference now to FIGS. 15-17, in yet another exemplary embodiment of the present invention, a dual mount assembly 400 comprises a goggle horn socket assembly 402 attachable to the rails 18 of the chassis base 16 and a tip-in socket assembly 404 attachable to the goggle horn socket assembly 402. Similarly to the previously discussed embodiments, fasteners 406 may be used to attach the socket assemblies 402, 404 by inserting the fasteners into bores 405 and threaded bores of the tip-in socket assembly and the goggle horn socket assembly, respectively. Although screws are shown as the fasteners 406, one of ordinary skill in the art will also appreciate that a latch, or other type of quick release fastener may also be used to connect the socket assemblies 402, 404 such that the socket assemblies could be separated without the use of a tool.

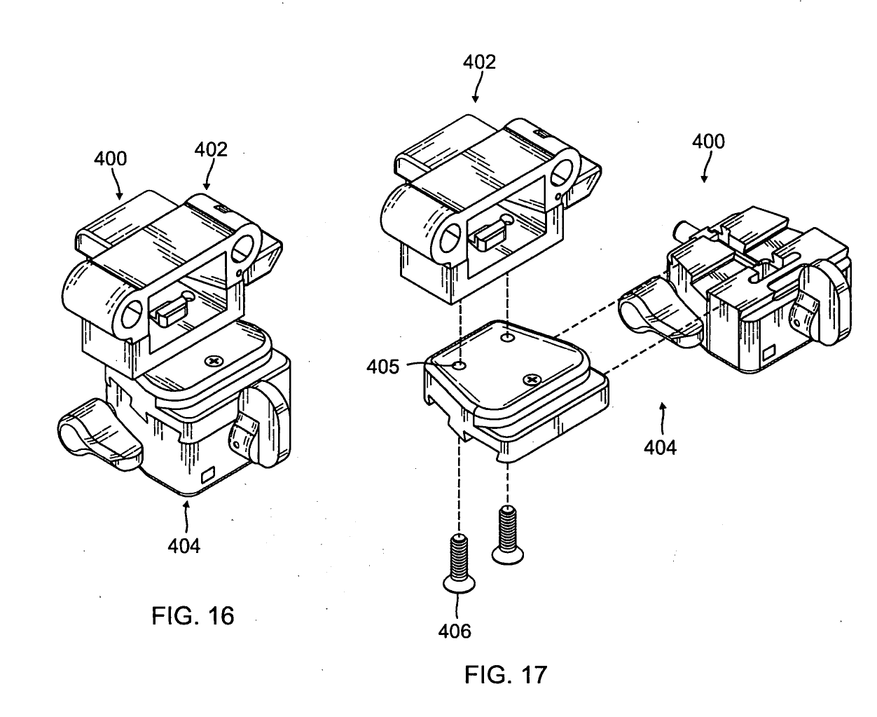

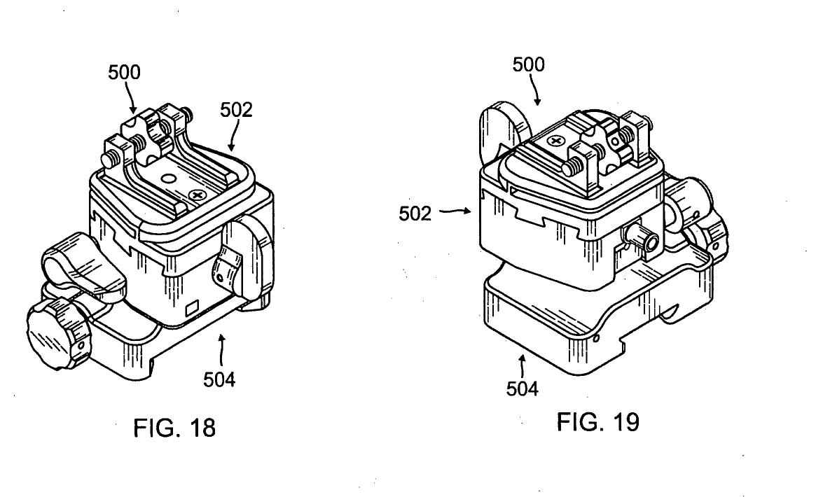

With reference now to FIGS. 18-20, in yet another exemplary embodiment of the present invention, a dual mount assembly 500 comprises a tip-in socket assembly 502 attachable to a night vision goggle helmet mount and a dovetail socket assembly 504 attachable to the tip-in socket assembly. In one exemplary embodiment, a top surface 506 of the dovetail socket assembly 504 includes an alignment protrusion 508 adapted to be received in an alignment recess of a tip-in hot shoe 512. A fastener 514 may be inserted into a through hole 516 in the tip-in hot shoe 512 and threaded into a bore 518 in the alignment protrusion 508 to attach the tip-in hot shoe to the dovetail socket assembly 504. Similarly, as shown in FIGS. 21-23, a dual mount assembly 600 includes a goggle horn socket assembly 602 having an alignment protrusion 604 on a top surface. The alignment protrusion 604 is insertable into a recess of a tip-in hot shoe 608. A fastener 606 may be inserted into a through hole 610 of the tip-in hot shoe 608 and into a bore 612 in the alignment protrusion 604 to attach the tip-in hot shoe to the goggle horn socket assembly 602. The tip-in hot shoe 608 may then be inserted into a tip-in interface of an ENVG housing as described above.

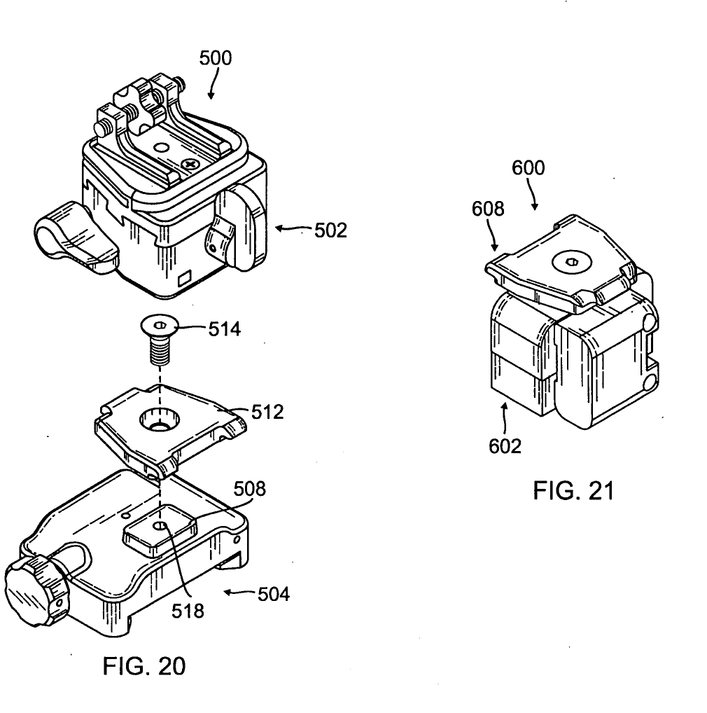

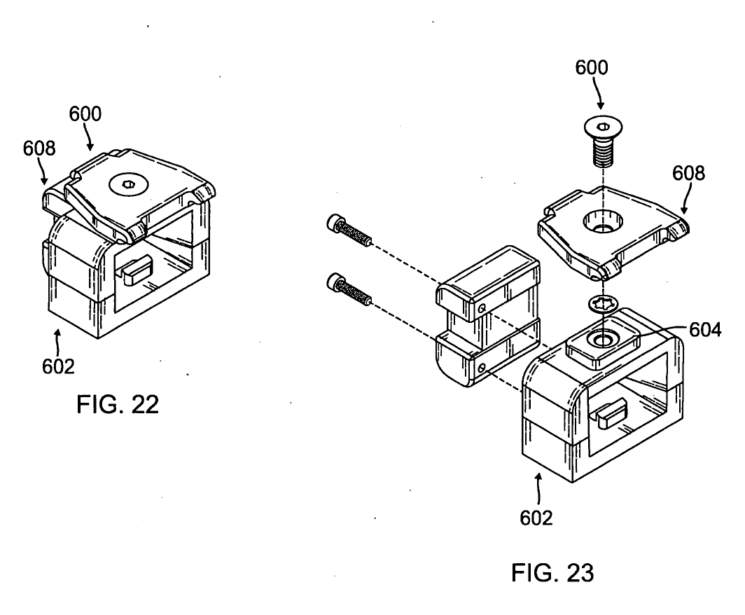

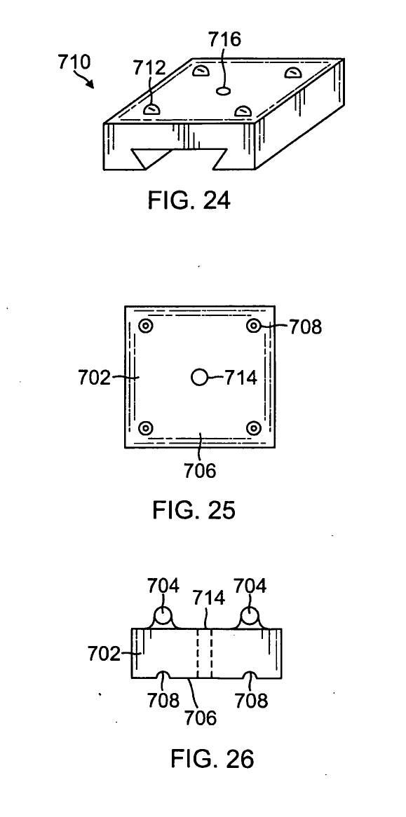

With reference now to FIGS. 25 and 26, a universal attachment member 702 is shown having two bores 704 slidably attachable to the rails 18 of the chassis base 16, as described above. The universal attachment member 702 includes a relatively flat bottom surface 706 having recesses 708 adapted to receive and mate with protrusions 712 from, for example, a dovetail socket assembly 710 (FIG. 24) such that when an attachment assembly is attached to the universal attachment member, relative rotation between the attachment assembly and the universal attachment member is substantially prevented. The attachment member 702 may further include a bore 714 into which a fastener, such as a screw, may be inserted. Although the present embodiment is described with reference to only a single fastener, multiple fasteners may also be used. As shown in FIG. 24, the dovetail socket assembly 710 has protrusions 712 that are insertable into the recesses 708 in the universal attachment member 702 and a through hole 716 adapted to receive a fastener. As such, the dovetail socket assembly 710 can be attached to the universal attachment member 702. As one of ordinary skill in the art will appreciate, a goggle horn socket assembly, a tip-in socket assembly, or other socket assemblies may also have a similar flat top surface with protrusions attachable to the universal attachment member 702. Accordingly, if socket assemblies are provided modularly, each having a top surface compatible with the universal attachment member 702, each socket assembly could be attached to the universal attachment member. Moreover, after an initial socket assembly is attached to the universal attachment member 702, additional socket assemblies could be attached to the initial socket assembly and to each other, as described above.

Although various exemplary embodiments of universal mount assemblies are shown and described, one of ordinary skill in the art will appreciate that additional combinations of socket assemblies and other night vision goggle attachment assemblies are also possible. For example, a dovetail socket assembly, a goggle horn socket assembly and a tip-in socket assembly could all be combined together in a tri-mount assembly such that night vision goggles with any of the three corresponding interfaces could be mounted to the night vision goggle mount. Further, the particular order of the socket assemblies is not critical, and the socket assemblies could be mounted in any order. Additionally, although particular fasteners are described, one of ordinary skill in the art will appreciate that other fasteners, such as a quick-release latch or a slidable dovetail assembly, may be used to connect the socket assemblies.

What is claimed is:

1. A mount for night vision goggles comprising:
a bracket configured to attach the mount to headgear;
a chassis base extending from the bracket;
a first socket assembly attached to the chassis base, the first socket assembly adapted to receive a first type of night vision goggle attachment; and
a second socket assembly configured to mate with a second type of night vision goggle attachment, the second socket assembly attachable to the first socket assembly to substantially prevent relative movement between the first socket assembly and the second socket assembly.

2. The mount of claim 1, wherein the first socket assembly is stacked onto the second socket assembly.

3. The mount of claim 1, the chassis base further comprising a pair of rails and the first socket assembly comprising a pair of bores for mounting the first socket assembly on the pair of rails.

4. The mount of claim 1, wherein the first socket assembly and the second socket assembly each have at least one bore for receiving a fastener to attach the first socket assembly to the second socket assembly.

5. The mount of claim 1, wherein the second socket assembly is attached to the first socket assembly by a single fastener.

6. The mount of claim 1, the second socket assembly further comprising an alignment protrusion extending from a top surface, wherein the first socket assembly has an alignment cavity adapted to receive the alignment protrusion.

7. The mount of claim 6, wherein the alignment protrusion is a non-radially symmetrical shape.

8. The mount of claim 6, wherein a fastener is insertable into the alignment cavity and the alignment protrusion to attach the first socket assembly to the second socket assembly.

9. The mount of claim 1, wherein the first socket assembly is a socket assembly selected from a dovetail assembly, a goggle horn assembly, and a tip-in assembly, and wherein the second socket assembly is another socket assembly selected from a dovetail assembly, a goggle horn assembly, and a tip-in assembly.

10. The mount of claim 9, wherein the first socket assembly is a tip-in assembly, and wherein the second socket assembly includes a tip-in hot shoe attached to a top surface, the tip-in hot shoe adapted to attach the second socket assembly to the first socket assembly.

11. The mount of claim 10, the second socket assembly further including an alignment protrusion attached to the top surface, the alignment protrusion adapted to be inserted into an alignment cavity of the tip-in hot shoe.

12. The mount of claim 9, wherein the tip-in hot shoe is attached to the second socket assembly by a fastener.

13. The mount of claim 1, wherein the second socket assembly is attached to the first socket assembly by a plurality of fasteners.

14. The mount of claim 13, wherein the plurality of fasteners are screws.

15. The mount of claim 1, further comprising an automatic shutdown assembly device attached to at least one of the first socket assembly and the second socket assembly.

16. The mount of claim 15, wherein the automatic shutdown assembly is a magnet module.

17. A mount for night vision goggles comprising:
a bracket configured to attach the mount to headgear;
a chassis base extending from the bracket and including a pair of rails;
a universal attachment member defining a first surface comprising a pair of through holes slidably attachable to the pair of rails and defining a second surface opposite the first surface having one of protrusions or recesses for receiving a night vision goggle socket assembly; and
a night vision goggle socket assembly defining a first surface including the other of protrusions or recesses configured to mate with the protrusions or recesses on the second surface of the universal attachment member.

18. The mount of claim 17, further comprising a fastener for attaching the universal attachment member to the night vision goggle socket assembly.

19. The mount of claim 18, wherein the night vision goggle socket assembly is a socket assembly selected from a dovetail assembly, a goggle horn assembly, and a tip-in assembly.
